(19) United States
(12) Patent Application Publication
(10) Pub. No.: US 2008/0288381 A1
(43) Pub. Date: Nov. 20, 2008

(54) STUDENT HOUSING INVESTMENT PROCESS

(76) Inventor: Wayne T. Senecal, Austin, TX (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/748,824

(22) Filed: May 15, 2007

(51) Int. Cl. G06Q 10/00; G06Q 40/00

(52) U.S. Cl. 705/35

(57) ABSTRACT

A method of investing in a multi-unit residential property used for housing students registered with and attending a academic or quasi-academic institution. The residential property is configured to include common areas and one or more apartments, wherein each apartment further includes common areas and one or more bedroom spaces. Ownership interest in the property is transferred from a first entity to a second entity, and fractional ownership interests in the property are transferred from the second entity to one or more third entities. Factional ownership interest in the property includes occupancy rights to a specific bedroom space. The exclusive ownership interest in the specific bedroom space extends further to include non-exclusive ownership interest with accessibility and usage rights to the common areas associated with the apartment having the specific bedroom space and with the property. Criteria for acquiring, occupying, and/or retaining the fractional ownership interest in the property are established by the second entity.

### TECHNICAL FIELD

The present invention is a method for acquiring an ownership interest in a residential unit within a multi-unit residential property for housing students associated with an academic institution. More specifically, the invention relates to a method for acquiring a fractional ownership interest in a residential property for student occupancy.

### BACKGROUND

For students attending academic or quasi-academic institutions it is often desirable and advantageous, and sometimes necessary, to live on or within close proximity of the campus of the institution. As such, there is usually a demand for rental residential student housing located near the campus. However, renting a residential unit is not an attractive financial proposition because there is no financial gain from paying rent.

One approach for circumventing these difficulties includes purchasing a residential property on or within close proximity of the campus. However, this also may not be attractive due to efforts required for finding and financing a suitable residential property, or property maintenance requirements, or the likelihood of the student relocating after graduation.

Accordingly, there is a need for providing suitable residential housing for students whereby a property interest in a residential unit can be acquired as a potential investment at an affordable price and requiring minimal, if any, need for the student to maintain the property. It would also be advantageous to be able to realize an attractive rate of return from the property interest when it is sold or otherwise transferred.

### SUMMARY

The present invention is a method of acquiring a fractional ownership interest in a multi-unit residential property located on or within close proximity of the campus of an academic or quasi-academic institution.

In accordance with an embodiment of the invention, a first entity constructs and/or purchases a multi-unit residential property comprising common area(s) and one or more apartments, wherein each apartment is configured to include common area(s) and one or more different types of bedroom spaces. Next, an ownership interest in the residential property is acquired by a second entity from the first entity. The second entity establishes an ownership, occupancy, and usage scheme whereby a qualified third entity acquires a fractional ownership interest in the residential property. The fractional ownership interest in the residential property acquired by the qualified third entity includes an exclusive ownership interest and occupancy rights to a specific bedroom space; and a non-exclusive ownership interest in the common areas within the property and in the common areas within the apartment having the specific bedroom spaces. The non-inclusive ownership interest in the common areas includes rights to access and use those common areas. The responsibility for the management, including maintenance, of the entire residential property including all common areas associated with the residential property and those within each apartment, resides with the second entity.

In accordance with an embodiment of the invention, a qualified third entity is defined as a qualified student and/or a parent/guardian of a qualified student; and a qualified student is defined as a student registered with and attending the academic or quasi-academic institution.

According to an embodiment of the invention, the bedroom occupancy and usage scheme established by the second entity, and agreed to by the qualified third entity acquiring the fractional ownership interest in the property, includes the requirement that the bedroom must be occupied by a qualified student as a resident therein. As such, and in accordance with an embodiment of the invention, the bedroom space is occupied by the student as the qualified third entity owner and/or by the student related to the qualified third entity owner. Alternatively, the qualified third entity rents the occupancy rights in the bedroom space to a qualified student. These occupancy rights rented to a qualified student includes rights to access and use the common areas within the property and the common areas within the apartment having the bedroom therein.

In an embodiment of the invention, the third entity's fractional ownership interest in the residential property is in the form of a full ownership, or a fractional deeded interest, or a fixed or floating time share interest, or a cooperative interest. In another embodiment, the third entity's fractional ownership interest in the residential property is financed with a cash purchase, or a mortgage on the fractional ownership interest, or financing by the first and/or the second entity, or a student loan.

While exemplary embodiments of the instant invention are disclosed, additional embodiments may become apparent to those skilled in the art. The following detailed description shows and describes illustrative embodiments of the present invention. As will be realized, the embodiment are capable of modifications in various aspects, all without departing from the spirit and scope of the instant invention. Accordingly, the drawings and detailed description are to be regarded as illustrative in nature and not restrictive.

### BRIEF DESCRIPTION OF THE DRAWINGS

FIG. 1 is a block diagram representation of a multi-unit residential property for student housing.

FIG. 2 illustrates the overall investment process for establishing ownership rights in the property of FIG. 1.

FIG. 3 is a block diagram representation of bedroom occupancies in the multi-unit residential property of FIG. 1 in accordance with an embodiment of the invention.

FIG. 4 illustrates the student housing investment and bedroom occupancy process in accordance with an embodiment of a method of the invention.

### DETAILED DESCRIPTION

While the present invention is subject to various modifications, embodiments for carrying out the invention are described herein below with reference to the included figures. However, it should be clearly understood that there is no intention to limit the invention to any of the disclosed embodiments, forms, or examples. On the contrary, alternate embodiments, methods, modifications, and processes are construed as falling within the spirit and scope of the invention as defined by the appended claims.

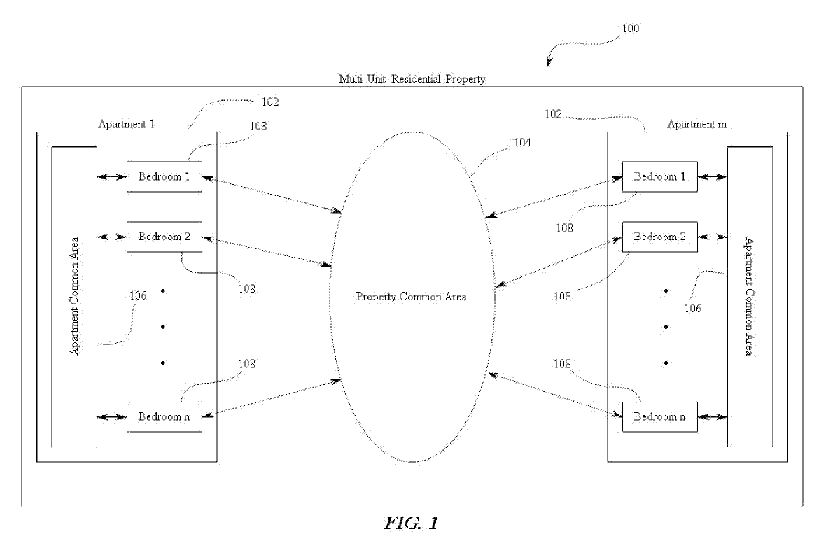

FIG. 1 is a block diagram representation of a multi-unit residential property 100 configured for student housing. Property 100 includes one or more apartments 102 shown as apartments 1 through m, and one or more property common areas 104 accessible and useable by all occupants of property 100. Each apartment 102 further includes one or more apartment common areas 106 and one or more bedroom spaces 108 shown as bedrooms 1 through n. Each of the one or more apartments 102 is the same or different from one another with respect to the floor area, number and size of bedroom spaces 108, and configuration. The one or more apartment common areas 106 in each apartment 102 are accessible and useable by all occupants of each bedroom space 108 within that apartment 102.

In accordance with an embodiment of the invention, property 100 is located on the campus or within close proximity of the campus of an academic or quasi-academic institution. Property 100 presents a qualified third entity an investment opportunity by acquiring a fractional ownership interest in property 100 through the acquisition of an ownership interest and occupancy rights in a specific bedroom space 108 within property 100. A qualified third entity is defined as a qualified student and/or a parent/guardian of a qualified student; and furthermore, a qualified student is defined as a student registered at and attending the institution.

The third entity's acquisition of a fractional ownership interest in property 100 is accomplished by one or more of several financing options used singularly or combinatorially. In an embodiment of the invention, the third entity completes it's investment with a cash payment of the entire amount. Alternately, the third entity uses a combination of cash and financing. In one such embodiment, the financing is provided by the first entity and/or the second entity. Alternately, the financing is through obtaining a student loan and/or a mortgage on the ownership interest in property 100. Several options for financing the investment are possible as alternative embodiments, all of which options are considered being within the scope, intent, and bounds of the present invention.

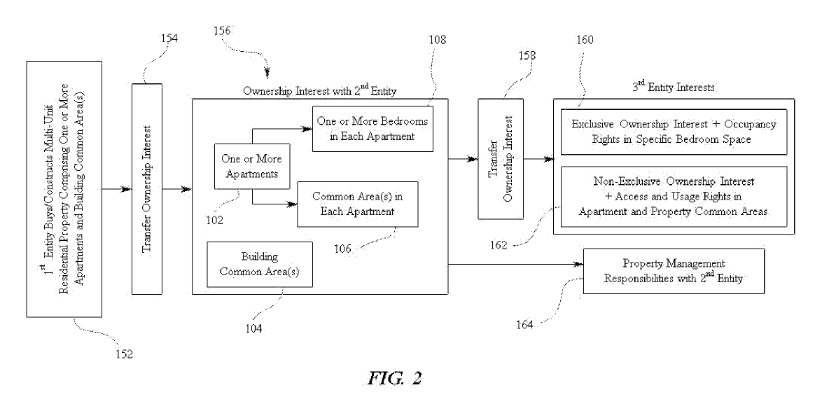

FIG. 2 illustrates the overall investment process for acquiring fractional ownership interest in property 100. In accordance with an embodiment of the invention, the first entity acquires property 100 at block 152 through purchasing or constructing. If necessary, property 100 is renovated and/or remodeled into a configuration, such as that shown in FIG. 1, having property common areas 104 and apartments 102, wherein each apartment 102 further includes apartment common areas 106 and bedroom spaces 108. Next, the ownership interest in property 100 is transferred, as shown at block 154, from the first entity to a second entity. In an embodiment of the invention, full ownership interest in property 100 is transferred from the first entity to the second entity. The ownership interest in property 100 residing with the second entity initially includes full ownership interests in apartments 102 and in property common areas 104 within property 100. Furthermore, the second entity's initial ownership interest in each apartment 102 extends to full ownership interests in apartment common areas 106 and in each bedroom space 108 within each apartment 102. Alternately, the second entity acquires a partial ownership interest in property 100. In accordance with an embodiment of the invention, transfer of the ownership interest in property 100 is in the form of a leasehold or fee interest. As such, the second entity is a property management group, or an investment group, or an asset management group. In one such embodiment, the first entity retains full ownership interest in property 100 and the second entity provides property management services.

In accordance with an embodiment of the invention, exclusive ownership interest in bedroom space 108, as shown at block 160, can be acquired by none other than a qualified third entity. In one such embodiment, the exclusive ownership interest in a specific bedroom space 108 includes an occupancy right in the specific bedroom space 108. In another embodiment of the invention, and as shown at block 162, the exclusive ownership interest in bedroom space 108 extends to include a non-exclusive ownership interest in apartment common areas 106 within apartment 102 having bedroom spaces 108, and a non-exclusive ownership interest in property common areas 104 within property 100 containing apartment 102. The non-exclusive ownership interest in property and apartment common areas 104 and 106, respectively, includes access and usage rights in these common areas. As can be seen, the third entity's exclusive ownership interest in bedroom space 108, and non-exclusive ownership interest in property and apartment common areas 104 and 106, respectively, is equivalent to a fractional ownership interest in property 100.

In one such embodiment, the second entity establishes the guidelines for allocating the one or more non-exclusive ownership interests. In an embodiment of the invention, the non-exclusive ownership interests in property and apartment common areas 104 and 106, respectfully, are correlated with the exclusive ownership interest in bedroom space 108. In one instance, the correlation is based on the floor area of bedroom space 108 relative to that of property 100, or the monetary value of bedroom space 108, or the location of bedroom space 108.

In an embodiment of the invention, the third entity's fractional ownership interest in property 100 is in the form of a time share interest conferring a recurring occupancy right during a specified period each year. In another embodiment, the third entity's fractional ownership interest in property 100 is in the form of a floating time share interest conferring an occupancy right for a specific number of days or weeks each year during same and/or different period each year. In yet another embodiment, the third entity's fractional ownership interest in property 100 is in the form of a cooperative interest such as by acquiring one or more shares and/or stock in a cooperative association or corporation. In one such embodiment, the fractional ownership interest in property 100 includes a proprietary lease conferring occupancy rights to one or more bedroom spaces 108.

As shown at block 164, management of the multi-unit residential property 100 including all common areas such as property common areas 104 within property 100 and all apartment common areas 106 in each apartment 102 within property 100 resides with the second entity. In accordance with an embodiment of the invention, the second entity is responsible for tasks including maintaining and operating the property, and overseeing the occupancy as being limited to qualified students. In another embodiment (not shown), the property management responsibilities extend to include each bedroom space 108. In an alternate embodiment (also not shown), the property management responsibilities do not extend to include each bedroom space 108. In yet another embodiment (not shown), the second entity retains management responsibilities for portions of property 100 including property common areas 104, whereas the management responsibilities for each apartment 102, including each bedroom space 108 and apartment common areas 106, resides with the one or more third entity having exclusive ownership interest in the one or more bedroom spaces 108 within that apartment 102. As can be seen, several alternative embodiments and/or combinations of different embodiments are possible for assigning and carrying out the management responsibilities. In one such embodiment, a suitable management organization is hired and/or otherwise contracted with for performing one or more of the property management tasks. All such alternative embodiments for property management are considered as being within the scope, intent, and bounds of the instant invention.

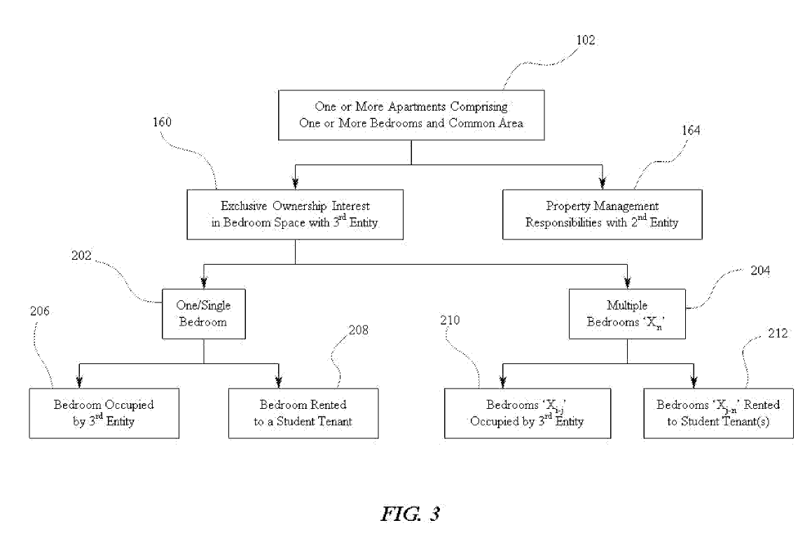

In an embodiment of the invention, the third entity is mandated to ensure that at least one qualified student resides in each of the specific bedroom space 108 in which the third entity has acquired exclusive ownership interest. FIG. 3 illustrates bedroom occupancies by one or more qualified students in accordance with one such embodiment of the invention. As has been discussed, property 100 includes property common areas 104 and one or more apartments 102; wherein each apartment 102 includes one or more bedroom spaces 108 and apartment common areas 106. According to the embodiment of the invention illustrated by FIG. 3, and as represented by block 164, the second entity is responsible for managing property 100, including property common areas 104 and apartment common areas 106. Additionally, as represented by block 160, the exclusive ownership interest in specific bedroom space 108 is acquired by the third entity. As shown, the third entity's exclusive ownership interest is in a specific single bedroom space 202 and/or in specific multiple bedroom spaces 204. As has been discussed, the third entity's exclusive ownership interest in bedroom space 108 extends to include non-exclusive ownership interests, and access and usage rights in both property and apartment common areas 104 and 106, respectively.

If the third entity acquires exclusive ownership interest in a specific single bedroom space 202, then bedroom space 202 is either occupied by the qualified third entity 206 or, as shown at block 208, bedroom space 202 is rented to a qualified student as a tenant. In accordance with an embodiment of the invention, if the third entity acquires exclusive ownership interest in specific multiple bedroom spaces 204, then all bedroom spaces 204 are occupied by qualified students. In an alternate embodiment, one or more of the multiple bedroom spaces 204 are occupied by the third entity as shown at block 210 and the remaining bedroom spaces 204 are rented to one or more qualified students as tenants as shown at block 212. In an embodiment of the invention, the renting of one or more bedroom spaces to one or more qualified student, such as shown at blocks 208 and 212, includes the renting of occupancy rights to the bedroom space, and access and usage rights to the property and apartment common areas 104 and 106, respectively. Such renting of occupancy rights is in the form of a time share or renting.

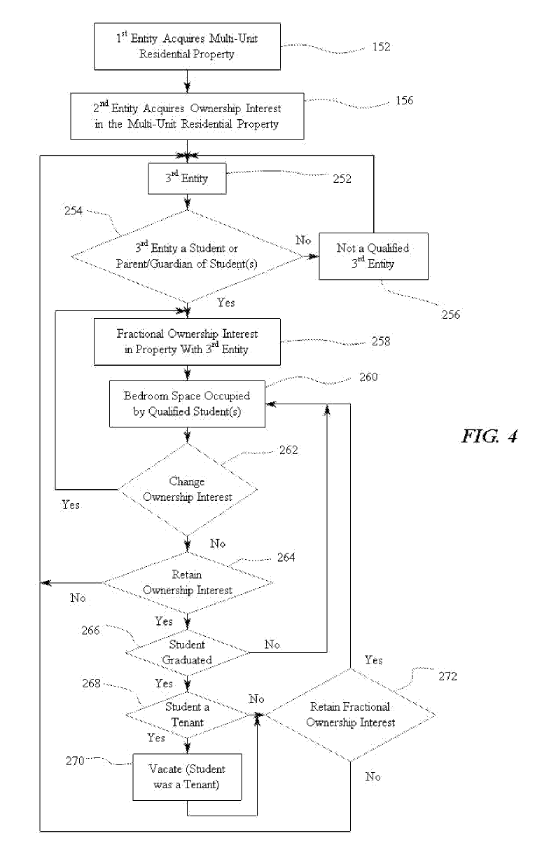

FIG. 4 is an illustration of a method for student housing investment process in accordance with an embodiment of the invention. The process starts at block 152 with a first entity's acquisition of a multi-unit residential property 100. As previously discussed, property 100 includes apartments 102 as well as common areas 104 that are accessible and useable by all occupants of property 100. Each apartment 102 further includes bedroom space 108 and common areas 106 accessible and useable by all occupants of bedroom 108. In accordance with an embodiment of the invention, block 156 shows a second entity acquiring ownership interest in property 100. As previously discussed, the ownership interest in property 100 residing with the second entity at block 156 includes management responsibilities and ownership interests in apartments 102, common areas 104 and 106, and bedroom spaces 108. Also as previously discussed, alternative options for management and/or ownership are possible either singularly or combinatorially.

At block 252, a third entity expresses an interest in acquiring a fractional ownership interest in property 100. In accordance with an embodiment of the invention, decision block 254 determines whether or not the third entity is qualified to acquire occupancy rights in bedroom space 108 which, as previously discussed, is equivalent to acquiring a fractional ownership interest in property 100. Also as previously discussed, a qualified third entity is defined as a qualified student and/or a parent/guardian of a qualified student; and furthermore a qualified student is defined as a student registered at and attending an academic or quasi-academic institution. If the third entity is not a qualified student and/or a parent/guardian of a qualified student, then the third entity is disqualified at block 256 from acquiring any ownership interests in property 100, and the process returns to block 252 for one or more new third entity. If at block 254 the third entity is a qualified student and/or a parent/guardian of a qualified student, then the third entity is permitted at block 258 to participate in the investment process.

As shown at block 258, the qualified third entity participates in one of several ways including as a new and/or as a continuing third entity. In accordance with an embodiment of the invention, and as illustrated in block 258, a new qualified third entity can acquire a fractional ownership interest in property 100 and occupancy rights in a specific bedroom space 108. Alternately, an existing third entity having previously acquired fractional ownership interest in property 100 is eligible to continue holding its investment or change its current ownership interest. In an embodiment of the invention, changing an ownership interest is in the form of a like-for-like exchange. Alternately, the change is in the form of buying-up such as by increasing the investment such as for example by changing the ownership interest from a single bedroom space to a multiple bedroom space. Per another embodiment the change is in the form of buying-down such as by decreasing the investment such as for example by changing the ownership interest from a multiple bedroom space to a single bedroom space. As can be seen, several alternative embodiments are possible for accommodating a third entity's desire to change its investment, all of which are considered as being within the scope, bounds, and intent of the instant invention. Such changes, in accordance with an embodiment of the invention, must be consensual and mutually agreeable between two or more third entities and/or between the second entity and one ore more third entity. According to another embodiment of the invention, the second entity acquires the fractional ownership interest in property 100 from the third entity. Alternately, the fractional ownership interest in property 100 is transferred between two third entities in a private transaction and in accordance with the guidelines established by the first and/or the second entity having an ownership interest and/or management responsibilities in property 100. One such transaction requires interaction with and/or the involvement of the second entity, whereas another such transaction does not require interaction with and/or the involvement of the second entity.

As has been discussed, bedrooms 108 is occupied by one or more qualified student as indicated at block 260.

In accordance with an embodiment of the invention, the qualified third entity decides, as shown at 262, whether or not to exercise its option for a change in its ownership interest. If there is a desire to change the investment, and if it can be accommodated, then the transaction is completed at block 258. If a change is not requested and/or a request for change can not be accommodated, then the third entity having fractional ownership interest in property 100 considers, at block 264, whether or not to retain its investment. If the third entity decides not to retains its fractional ownership interest in property 100, then the process of locating a new qualified third entity begins at block 252. If the third entity decides to retain its fractional ownership interest in property 100, or if a qualified third entity is not available to take over the fractional ownership interest in property 100, then the process continues to block 266.

According with an embodiment of the invention, the third entity having fractional ownership interest in property 100 is mandated to ensure that a qualified student resides therein as the occupant. Accordingly, an inquiry of whether or not the student has graduated is made at block 266. If the student has not graduated, then the same student is permitted to continue occupying and residing in bedroom space 108, as shown at block 260. If the student has graduated, then a determination is made at block 268 as to whether or not the exclusive ownership interest in bedroom space 108 occupied by the student resides with the qualified student and/or with the parent/guardian of the qualified student. Essentially, the determination made at block 268 is whether or not the graduating student occupying and residing in bedroom space 108 is a qualified third entity or a student tenant. If the graduating student is a tenant then, as indicated at block 270, the student is required to vacate bedroom space 108 upon graduation. If the graduating student is identified at block 268 as a qualified third entity and/or after the graduating student residing as a tenant vacates bedroom space 108, the third entity having fractional ownership interest in property 100 is required at block 272 to decide whether or not it wants to continue retaining its fractional ownership interest in property 100. If the third entity decides not to retain its fractional ownership interest in property 100, then the process of locating a new qualified third entity begins at block 252. If the third entity decides to retain its fractional ownership interest in property 100, or if a qualified third entity is not available to take over the fractional ownership interest in property 100, then the process continues to block 260.

Various modifications and additions may be made to the exemplary embodiments discussed hereinabove without departing from the scope and intent of the present invention. For example, while the disclosed embodiments refer to particular features, the scope of the instant invention is considered to also include embodiments having different combinations of features that do not include all of the described features. Accordingly, the scope of the present invention is intended to embrace all such alternatives, modifications, and variations as falling within the scope and intent of the appended claims, including all equivalents thereof.

1. A method of providing residential student housing to a student tenant associated with an academic or quasi-academic institution comprising the steps of:
(a) acquiring a multi-unit residential property by a first entity, where the residential property includes apartments, each divided into one or more bedroom spaces and associated common areas;
(b) transferring an ownership interest in the multi-unit residential property from the first entity to a second entity;
(c) establishing a written occupancy scheme or plan that defines rights of exclusive occupancy for each bedroom space in each apartment, together with non-exclusive rights of use with respect to common areas within each apartment and within the multi-unit residential property, and correlates such exclusive and non-exclusive rights with the ownership of a specified fractional ownership interest in the multi-unit residential property;
(d) transferring, from the second entity to a third entity, one or more fractional ownership interests in the multi-unit residential property, with each fractional ownership interest carrying a corresponding right to exclusive use of one or more bedroom spaces and non-exclusive rights of use with respect to common areas; and
(e) providing for the granting by the third entity of an occupancy right to a student tenant, while the student tenant is associated with the academic or quasi-academic institution, with respect to a specific bedroom space and associated common areas, based on the third entity's rights derived from the fractional ownership interest of the third entity, or, when the third entity is a student, this occupancy right is derived directly from the student's ownership of the fractional interest.

2. The method of claim 1 wherein the multi-unit residential property is an existing property or is a new property developed by the first entity.

3. The method of claim 1 wherein the multi-unit residential property is located on a campus of the academic or quasi-academic institution, or wherein the multi-unit residential property is located off of a campus of the academic or quasi-academic institution.

4. The method of claim 1 wherein the first entity retains at least a partial ownership interest in the multi-unit residential property, or wherein the first entity transfers all of its ownership interest in the multi-unit residential property to the second entity.

5-6. (canceled)

7. The method of claim 1 wherein the ownership interest of the second entity is a leasehold or fee interest granted to the second entity by the first entity.

8. The method of claim 7 wherein the ownership interest of the second entity is a fee interest granted to the second entity by the first entity.

9. The method of claim 1 wherein the first entity is the academic or quasi-academic institution and wherein the ownership interest of the second entity is a leasehold interest granted to the second entity by the academic or quasi-academic institution.

10. (canceled)

11. The method of claim 1 wherein the second entity manages the occupancy rights and property functions of the multi-unit residential property.

12. The method of claim 1 wherein the third entity is a parent of the student tenant, or wherein the third entity is the student.

13. (canceled)

14. The method of claim 1 wherein a parent is a guarantor of obligations relating to the student's fractional ownership interest.

15. The method of claim 1 wherein the fractional ownership interest is a deeded fractional interest.

16. The method of claim 1 wherein the fractional ownership interest is a time share interest, that is, an interest that confers a recurring right of occupancy during a specified period each year.

17. The method of claim 16 wherein the fractional ownership interest is a floating time share interest, that is, an interest that confers a right of occupancy for a specified number of days or weeks each year, but not necessarily the same period each year.

18. The method of claim 1 wherein the fractional ownership interest is a cooperative interest, evidenced by a share or shares of stock in a cooperative association or corporation and accompanied by a proprietary lease governing rights of occupancy.

19. The method of claim 1 wherein the one or more bedroom spaces are associated with apartments containing one, two, three or more bedrooms and are divided into different groups of bedroom spaces according to the number of bedrooms in the apartment, and wherein the fractional ownership interest is associated with a particular group of bedroom spaces and the particular group includes one or more bedroom spaces that are substantially equivalent.

20. (canceled)

21. The method of claim 19 further comprising changing the student tenant's occupancy rights for a specific bedroom space for a different bedroom space within the same group without changing the fractional ownership interest of the third entity.

22. The method of claim 1 wherein the multi-unit residential property is managed by an asset manager that allocates the bedroom spaces in a group among two or more student tenants, each of whom has occupancy rights to the bedroom spaces in the group.

23. The method of claim 22 wherein the asset manager is the second entity.

24. A method of investing in residential student housing comprising the steps of:
(a) obtaining a fractional ownership interest from a co-ownership entity to one or more bedroom spaces and associated common areas in a multi-unit residential apartment property having one or more groups of different bedroom spaces and associated common areas;
(b) providing a student tenant with an occupancy right to the bedroom space and associated common areas for a predetermined period of time while the student tenant is associated with an academic or quasi-academic institution in accordance with the fractional ownership interest; and
(c) earning income on the fractional ownership interest associated with the student tenant occupancy right by charging the student tenant for the occupancy right, by selling the fractional ownership interest to a subsequent purchaser of the fractional ownership interest, or by both initially charging the student tenant and then selling the fractional ownership interest to a subsequent purchaser.

25. The method of investing of claim 24 wherein the fractional ownership interest is obtained by a parent of a student tenant, a student tenant, a student tenant guaranteed by a parent of the student or a third party.

26. The method of investing of claim 24 wherein the fractional ownership interest giving rise to the right to occupy a bedroom space and associated common areas is a fractional deeded interest, a fixed or floating time share interest, or a cooperative interest.

27. The method of investing of claim 26 wherein the fractional ownership interest is a floating time share interest.

28. The method of investing of claim 24 wherein the student tenant occupancy right is a paid time share right or a paid rental right.

29. The method of investing of claim 24 wherein the fractional ownership interest is managed by an asset manager and wherein the asset manager facilitates financing the fractional ownership interest.

30. (canceled)

31. The method of investing of claim 29 wherein the financing includes mortgages from third parties or wherein the financing includes student loans from third parties.

32. (canceled)
